(19) United States
(12) Patent Application Publication
(10) Pub. No.: US 2026/0252564 A1
(43) Pub. Date: Aug. 27, 2026

(54) DATA PROCESSING METHOD AND RELATED PRODUCTS

(71) Applicant: Huawei Cloud Computing Technologies Co., Ltd., Guizhou (CN)

(72) Inventors: Rene Andreasovich VAN BEVERN, Novosibirsk (RU); Roman Boyko, Novosibirsk (RU); Anton LOGINOV, Novosibirsk (RU)

(73) Assignee: Huawei Cloud Computing Technologies Co., Ltd., Guizhou (CN)

(21) Appl. No.: 19/648,341

(22) Filed: Apr. 15, 2026

Related U.S. Application Data
(63) Continuation of application No. PCT/RU2024/000074, filed on Mar. 5, 2024.

(30) Foreign Application Priority Data
Oct. 17, 2023 (WO) PCT/RU2023/000309

(51) Int. Cl. G06F 16/2453; G06F 16/2455

(52) U.S. Cl. CPC G06F 16/24545; G06F 16/24568

(57) ABSTRACT

The present disclosure provides a data processing method and related products, the method includes: consuming a first event in a data stream based on a first data structure corresponding to a first function, where the first function is used for finding a target value for a target attribute in the data stream, and a size of a resource occupied by the first data structure in a memory is determined according to an accuracy of a first estimation and with a sublinear cost, and the first estimation is an estimation of the target value; and obtaining the first estimation as an output of the first function based on the consumption.

### CROSS-REFERENCE TO RELATED APPLICATIONS

This application is a continuation of International Application No. PCT/RU2024/000074, filed on Mar. 5, 2024, which claims priority to International Application No. PCT/RU2023/000309, filed on Oct. 17, 2023. The disclosures of the aforementioned applications are hereby incorporated by reference in their entireties.

### TECHNICAL FIELD

The present disclosure relates to the field of stream processing technologies, and in particular, to a data processing method and related products.

### BACKGROUND

The purpose of a stream processing is to accept a sequence of events or records and to simultaneously (in real time or at least with low latency) output results of computations. Records can have several attributes, each of which takes a value.

This background information is provided to reveal information believed by the applicant to be of relevance to the present disclosure. No admission is necessarily intended, nor should be construed, that any of the preceding information constitutes prior art against the present disclosure.

### SUMMARY

In a first aspect, an embodiment of the present disclosure provides a data processing method, where the method includes:
consuming a first event in a data stream based on a first data structure corresponding to a first function, where the first function is used for finding a target value for a target attribute in the data stream, and a size of a resource occupied by the first data structure in a memory is determined according to an accuracy of a first estimation and with a sublinear cost, and the first estimation is an estimation of the target value; and
obtaining the first estimation as an output of the first function based on the consumption.

In this way, the data stream with or without retraction can be processed by using the first data structure, without storing the entire data stream, and the data structure can contain events of unbounded length, the memory use grows in an expected way with length of the data stream, thus reducing the memory requirement.

In an embodiment of the first aspect, where consuming the first event in the data stream based on the first data structure corresponding to the first function includes:
determining whether the first event is an arrival of data or a retraction of data; and
upon determining that the first event is the arrival of data, consuming the first event by using a first procedure; or
upon determining that the first event is the retraction of data, consuming the first event by using a second procedure.

In an embodiment of the first aspect, where the target value is a first target value;
where the first procedure includes:
determining an interval into which a value for the target attribute of an event falls, where the interval is one of multiple intervals set based on the accuracy; and
recording the value for the target attribute of the event by updating a parameter of the first data structure corresponding to the interval.

In an embodiment of the first aspect, where the second procedure includes:
determining an interval into which a value for the target attribute of an event falls, where the interval is one of multiple intervals set based on the accuracy; and
removing a record of the value for the target attribute of the event by updating a parameter of the first data structure corresponding to the interval.

Based on the first procedure, the first function allows for tracking the maximum, minimum, the k-th smallest value, percentiles, and medians in the data stream with retraction.

In an embodiment of the first aspect, where obtaining the first estimation as an output of the first function based on the consumption includes:
obtaining the first estimation as the first target value based on the parameter of the first data structure and the interval.

In an embodiment of the first aspect, where the first data structure is based on an exponential histogram, and the size of the resource occupied by the first data structure is proportional to a logarithm of a length of the data stream and logarithms of maximum and minimum absolute values in the data stream.

The number of bits occupied by each counter in the exponential histogram is proportional to the logarithm of the stream length. The memory overhead of an array or search tree realization will be larger only by a constant factor, thus reducing the memory usage.

In an embodiment of the first aspect, where the first target value is one of a maximum for the target attribute in the data stream, a minimum for the target attribute in the data stream or a k-th smallest value for the target attribute in the data stream, where k is specified in the first function.

In an embodiment of the first aspect, where the target value is a second target value for the target attribute among a first number of groups, and the first number is defined in the first function;
where the first data structure is based on a second number of exponential histogram sets, and each of the exponential histogram sets includes a third number of exponential histograms, where the second number is determined based on an error probability defined in the first function.

In this way, when the data stream is divided into multiple groups and to track maximum and minimum for each of the multiple groups, the number of groups may be too large to track an exponential histogram for each group, the group collapsing functionality of the present disclosure allows to estimate the maxima of the groups that are significant, in the following sense, thus avoiding the situation that the large number of groups (e.g., the number of all IPv6 addresses) exceeds the amount of addressable memory in most systems.

In an embodiment of the first aspect, where the first procedure includes:
for each of the exponential histogram sets, obtaining a first exponential histogram among the third number of exponential histograms in the exponential histogram set based on a value for a grouping attribute of an event, where the value of the grouping attribute is indicative of a group to which the event belongs;
determining, in the first exponential histogram, an interval into which the value for the target attribute of the event falls, where the interval is one of multiple intervals set based on the accuracy; and
recording the value for the target attribute of the event by updating a parameter of the first exponential histogram corresponding to the interval.

Based on the first procedure, the first function allows for tracking the maximum or minimum for the target attribute in each of several groups in the data stream without retraction in the case where the number of groups may be too large to track an exponential histogram for each group, thus avoiding the situation that the large number of groups exceeds the amount of addressable memory in most systems.

In an embodiment of the first aspect, where the second procedure includes:
for each of the exponential histogram sets, obtaining a first exponential histogram among the third number of exponential histograms in the exponential histogram set based on a value for a grouping attribute of an event, where the value of the grouping attribute is indicative of a group to which the event belongs;
determining, in the first exponential histogram, an interval into which the value for the target attribute of the event falls, where the interval is one of multiple intervals set based on the accuracy; and
removing a record of the value for the target attribute of the event by updating a parameter of the first exponential histogram corresponding to the interval.

Based on the second procedure, the first function allows for tracking the maximum or minimum for the target attribute in each of several groups in the data stream with retraction in the case where the number of groups may be too large to track an exponential histogram for each group, thus avoiding the situation that the large number of groups exceeds the amount of addressable memory in most systems.

In an embodiment of the first aspect, where obtaining the first estimation as an output of the first function based on the consumption includes:
obtaining candidate estimations based on the parameters of the first exponential histograms for the exponential histogram sets and the accuracy;
determining a to-be-verified estimation based on the candidate estimations; and
determining the first estimation as the second target value based on the first exponential histograms for the exponential histogram sets and the to-be-verified estimation.

By means of verifying, the quality of the output estimate can be ensured.

In an embodiment of the first aspect, where determining the first estimation as the second target value based on the first exponential histograms for the exponential histogram sets and the to-be-verified estimation includes:
for each of the exponential histogram sets, determining, among the third number of exponential histograms in the exponential histogram set, a number of second exponential histograms of which estimations are not smaller than the to-be-verified estimation; and
in a case that the number of second exponential histograms is not greater than the first number, outputting the to-be-verified estimation as the first estimation.

By means of the above processes, the quality of the output estimate can be ensured.

In an embodiment of the first aspect, where the first number is set by a user.

In an embodiment of the first aspect, the target value is a third target value for the target attribute in a group defined by the first function, and the first data structure is based on a count-min sketch algorithm;
where the first procedure includes:
taking a value for the target attribute of an event in the group to update the first data structure.

In an embodiment of the first aspect, where the second procedure includes:
taking a negative of the value for the target attribute of the event in the group to update the first data structure.

Based on the second procedure, the first function allows for tracking a count or sum over the target attribute of members in each group in the data stream with retraction.

In an embodiment of the first aspect, where the size of the resource occupied by the first data structure is proportional to a reciprocal of the accuracy, a logarithm of a reciprocal of an error probability of the first estimation and a logarithm of a length of the data stream.

In an embodiment of the first aspect, where the error probability is set by a user.

By setting the error probability by the user, memory use depends on the error probability desired by the user, the system user is free to find a trade-off between solution quality and the size of the resource.

In an embodiment of the first aspect, where the third target value is a sum over the target attribute of members in the group or a count over the target attribute of members in the group.

In an embodiment of the first aspect, where the method further includes:
obtaining a query request, where the query request is indicative of the first function and the accuracy; and
determining the first procedure or the second procedure based on the query request.

In an embodiment of the first aspect, where the accuracy is set by a user.

By setting the accuracy by the user, memory use depends on the accuracy desired by the user, the system user is free to find a trade-off between solution quality and the size of the resource.

In an embodiment of the first aspect, where the method further includes:
receiving the data stream, where the data stream includes the first event.

In a second aspect, an embodiment of the present disclosure provides a data processing apparatus, where the apparatus includes:
a consuming module, configured to consume a first event in a data stream based on a first data structure corresponding to a first function, where the first function is used for finding a target value for a target attribute in the data stream, and a size of a resource occupied by the first data structure in a memory is determined according to an accuracy of a first estimation and with a sublinear cost, and the first estimation is an estimation of the target value; and
obtaining module, configured to obtain the first estimation as an output of the first function based on the consumption.

In this way, the data stream with or without retraction can be processed by using the first data structure, without storing the entire data stream, and the data structure can contain events of unbounded length, the memory use grows in an expected way with length of the data stream, thus reducing the memory requirement.

In an embodiment of the second aspect, the consuming module is configured to:
determine whether the first event is an arrival of data or a retraction of data; and
upon determining that the first event is the arrival of data, consume the first event by using a first procedure; or
upon determining that the first event is the retraction of data, consume the first event by using a second procedure.

In an embodiment of the second aspect, where the target value is a first target value, the consuming module is configured to:
determine an interval into which a value for the target attribute of an event falls, where the interval is one of multiple intervals set based on the accuracy; and
record the value for the target attribute of the event by updating a parameter of the first data structure corresponding to the interval.

In an embodiment of the second aspect, where the consuming module is configured to:
determine an interval into which a value for the target attribute of an event falls, where the interval is one of multiple intervals set based on the accuracy; and
remove a record of the value for the target attribute of the event by updating a parameter of the first data structure corresponding to the interval.

Based on this, the first function allows for tracking the maximum, minimum, the k-th smallest value, percentiles, and medians in the data stream with retraction.

In an embodiment of the second aspect, where the obtaining module is configured to:
obtain the first estimation as the first target value based on the parameter of the first data structure and the interval.

In an embodiment of the second aspect, where the first data structure is based on an exponential histogram, and the size of the resource occupied by the first data structure is proportional to a logarithm of a length of the data stream and logarithms of maximum and minimum absolute values in the data stream.

The number of bits occupied by each counter in the exponential histogram is proportional to the logarithm of the stream length. The memory overhead of an array or search tree realization will be larger only by a constant factor, thus reducing the memory usage.

In an embodiment of the second aspect, where the first target value is one of a maximum for the target attribute in the data stream, a minimum for the target attribute in the data stream or a k-th smallest value for the target attribute in the data stream, where k is specified in the first function.

In an embodiment of the second aspect, where the target value is a second target value for the target attribute among a first number of groups, and the first number is defined in the first function;
where the first data structure is based on a second number of exponential histogram sets, and each of the exponential histogram sets includes a third number of exponential histograms, where the second number is determined based on an error probability defined in the first function.

In this way, when the data stream is participated into multiple groups and to track maximum and minimum for each of the multiple groups, the number of groups may be too large to track an exponential histogram for each group, the group collapsing functionality of the present disclosure allows to estimate the maxima of the groups that are significant, in the following sense, thus avoiding the situation that the number of all IPv6 addresses exceeds the amount of addressable memory in most systems.

In an embodiment of the second aspect, where the consuming module is configured to:
for each of the exponential histogram sets, obtain a first exponential histogram among the third number of exponential histograms in the exponential histogram set based on a value for a grouping attribute of an event, where the value of the grouping attribute is indicative of a group to which the event belongs;
determine, in the first exponential histogram, an interval into which the value for the target attribute of the event falls, where the interval is one of multiple intervals set based on the accuracy; and
record the value for the target attribute of the event by updating a parameter of the first exponential histogram corresponding to the interval.

Based on this, the first function allows for tracking the maximum or minimum for the target attribute in each of several groups in the data stream without retraction in the case where the number of groups may be too large to track an exponential histogram for each group, thus avoiding the situation that the large number of groups exceeds the amount of addressable memory in most systems.

In an embodiment of the second aspect, where the consuming module is configured to:
for each of the exponential histogram sets, obtain a first exponential histogram among the third number of exponential histograms in the exponential histogram set based on a value for a grouping attribute of an event, where the value of the grouping attribute is indicative of a group to which the event belongs;
determine, in the first exponential histogram, an interval into which the value for the target attribute of the event falls, where the interval is one of multiple intervals set based on the accuracy; and
remove a record of the value for the target attribute of the event by updating a parameter of the first exponential histogram corresponding to the interval.

Based on this, the first function allows for tracking the maximum or minimum for the target attribute in each of several groups in the data stream with retraction in the case where the number of groups may be too large to track an exponential histogram for each group, thus avoiding the situation that the large number of groups exceeds the amount of addressable memory in most systems.

In an embodiment of the second aspect, where the obtaining module is configured to:
obtain candidate estimations based on the parameters of the first exponential histograms for the exponential histogram sets and the accuracy;
determine a to-be-verified estimation based on the candidate estimations; and
determine the first estimation as the second target value based on the first exponential histograms for the exponential histogram sets and the to-be-verified estimation.

By means of verifying, the quality of the output estimate can be ensured.

In an embodiment of the second aspect, where the obtaining module is further configured to:
for each of the exponential histogram sets, determine, among the third number of exponential histograms in the exponential histogram set, a number of second exponential histograms of which estimations are not smaller than the to-be-verified estimation; and
in a case that the number of second exponential histograms is not greater than the first number, output the to-be-verified estimation as the first estimation.

By means of verifying, the quality of the output estimate can be ensured.

In an embodiment of the second aspect, where the first number is set by a user.

In an embodiment of the second aspect, where the target value is a third target value for the target attribute in a group defined by the first function, and the first data structure is based on a count-min sketch algorithm;
where the consuming module is configured to: take a value for the target attribute of an event in the group to update the first data structure.

In an embodiment of the second aspect, where the consuming module is configured to: take a negative of the value for the target attribute of the event in the group to update the first data structure.

Based on this, the first function allows for tracking a count or sum over the target attribute of members in each group in the data stream with retraction.

In an embodiment of the second aspect, where the size of the resource occupied by the first data structure is proportional to a reciprocal of the accuracy, a logarithm of a reciprocal of an error probability of the first estimation and a logarithm of a length of the data stream.

In an embodiment of the second aspect, where the error probability is set by a user.

By setting the error probability by the user, memory use depends on the error probability desired by the user, the system user is free to find a trade-off between solution quality and the size of the resource.

In an embodiment of the second aspect, where the third target value is a sum over the target attribute of members in the group or a count over the target attribute of members in the group.

In an embodiment of the second aspect, where the consuming module is further configured to:
obtain a query request, where the query request is indicative of the first function and the accuracy; and
determine the first procedure or the second procedure based on the query request.

In an embodiment of the second aspect, where the accuracy is set by a user.

By setting the accuracy by the user, memory use depends on the accuracy desired by the user, the system user is free to find a trade-off between solution quality and the size of the resource.

In an embodiment of the second aspect, where the apparatus further includes:
a receiving module, configured to receive the data stream, where the data stream includes the first event.

In a third aspect, an embodiment of the present disclosure provides a computing device cluster, including a processing circuitry for performing the data processing method according to the first aspect or any embodiment of the first aspect.

In a fourth aspect, an embodiment of the present disclosure provides a computer program product including program code for performing the data processing method according to the first aspect or any embodiment of the first aspect.

In a fifth aspect, an embodiment of the present disclosure provides an electronic device including processing circuitry for executing the data processing method according to the first aspect or any embodiment of the first aspect.

In a sixth aspect, an embodiment of the present disclosure provides a chip, including an input/output (I/O) interface and a processor, wherein the processor is configured to call and run a computer program stored in a memory, to enable a device installing with the chip to perform the method according to the first aspect or any embodiment of the first aspect.

In a seventh aspect, an embodiment of the present disclosure provides a computer-readable medium storing computer execution instructions which, when executed by a processor, causes the processor to execute the data processing method according to the first aspect or any embodiment of the first aspect.

In the data processing method according to the present disclosure, consume a first event in a data stream based on a first data structure corresponding to a first function, where the first function is used for finding a target value for a target attribute in the data stream, and a size of a resource occupied by the first data structure in a memory is determined according to an accuracy of a first estimation and with a sublinear cost, and the first estimation is an estimation of the target value; and obtain the first estimation as an output of the first function based on the consumption. In this way, the data stream with or without retraction can be processed by using the first data structure, without storing the entire data stream, and the data structure can contain events of unbounded length, the memory use grows logarithmically with length of the data stream, thus reducing the memory requirement.

### BRIEF DESCRIPTION OF DRAWINGS

FIG. 1 is a schematic structural diagram of an exemplary stream processing system according to one or more embodiments of the present disclosure.

FIG. 2 is a schematic structural diagram of an exemplary process of executing an SQL query according to one or more embodiments of the present disclosure.

FIG. 3 is a schematic flowchart of a data processing method according to one or more embodiments of the present disclosure.

FIG. 4 shows a schematic diagram of an exemplary data structure according to one or more embodiments of the present disclosure.

FIG. 5 shows a schematic diagram of an exemplary data structure according to one or more embodiments of the present disclosure.

FIG. 6 shows a schematic structural diagram of a data processing apparatus according to one or more embodiments of the present disclosure.

### DESCRIPTION OF EMBODIMENTS

To describe the technical solutions in embodiments of the present disclosure or in the prior art more clearly, the following briefly introduces the accompanying drawings needed for describing the embodiments or the prior art.

In the following description, reference is made to the accompanying figures, which form part of the present disclosure, and which show, by way of illustration, aspects of embodiments of the present disclosure or aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

A stream processing system is usually realized as a software in form of a distributed system running on a cluster. The system is programmable via an application programming interface (API) that allows a data analysis expert or an application developer to formulate queries over streams, specify stream sources and output sinks. The stream processing system then automatically manages the load balancing of cluster nodes, scheduling computations on cluster nodes, message routing between cluster nodes, and failure recovery of cluster nodes so as to maximize the processing throughput (records per seconds processed) and minimizing output latency.

Dozens of stream processing systems are known in the scientific literature or available as open source solutions. Cloud providers offer users commercial access to stream processing systems on clusters in the cloud. To name a few, the following stream processing systems are provided as cloud services, e.g., Apache Flink, Apache Storm, etc. Stream processing capabilities are also provided by e.g., Google BigQuery, DataBricks, etc.

Additionally, stream processing systems are actively studied in academics, by far not all systems have gone into productive use.

The purpose of a stream processing system is to accept a sequence of events or records and to simultaneously (in real time or at least with low latency) output results of computations. Records can have several attributes, each of which takes a value. Two examples of streams (which are also referred to as data streams below) are given below.

Example 1: the stream is a sequence of online book store orders. Each order yields a record. The attributes of the records are book ID, book title, selling price. The result of the computation is a ranking of the most-sold books, or a list of highest selling price for each book title.

Example 2: the stream is a sequence of machine health measurements. The attributes of records are machine ID, temperature, revolutions per minute. The result of the computation is a stream of control events: slow down or speed up the machine.

A common use case of stream processing systems is computing aggregate statistics. In real-time, records that have the same combinations of values in specified grouping attributes are partitioned into groups. Within each group, some aggregate function of an attribute is tracked, such as maximum, minimum, or average.

Throughout this description, a logarithm is understood as a base-2 logarithm and is simply denoted as “log(x)”.

A universal family of hash functions is a set of functions mapping values from some set V to some set U such that, when choosing a random function h from the family, then for each two distinct values v₁, v₂∈V, one has:

$$Pr [ h ( {v}_{1} ) = h ( {v}_{2} ) ] \leq \frac{1}{\vert U \vert}$$

Where Pr[h(v1)=h(v2)] represents the probability of h(v1)=h(v2), an example for a universal family of hash functions is the H₃ family: It maps binary strings to binary strings by interpreting the input as a q-dimensional vector over the binary field consisting over the set {0,1} and multiplying it by a random binary matrix with q columns. Additional random columns can be generated on demand if strings longer than q bits arrive. One can thus, conceptually, consider V to be the set of all binary strings by appending a one and an arbitrary number of zeroes to each string (the one is needed so that the padding will not map different strings to the same padded strings).

In order to give the stream processing system enough opportunities for doing automatic management of computational resources, queries can be formulated using a high-level query language like a structured query language (SQL). SQL is a query language for a relational database management system (DBMS) standardized by the International Organization for Standardization (ISO). In order to apply SQL to a data stream, the data stream is reinterpreted as a sequence of row insertions, row deletions, or row updates applied to a table in a relational DBMS. This table has potentially unbounded size and thus, generally, cannot be explicitly stored. Thus, the table has to be analyzed by just looking at the sequence of table modifications, not by looking at the table as a whole. Not all computations are feasible in this limited scenario. In the terminology of stream processing system, a row insertion is an arrival of a record (which is also referred to as an event herein) in the data stream; the row deletion is a retraction of a record; an update can be considered as a retraction followed by an insertion of an altered row. Among them, the data stream can include one or more records or events.

The output of the stream processing system can also be interpreted as a sequence of updates or as a sequence of row insertions and row deletions, applied to a (potentially infinitively large) table representing the output. Thus, the output of one computation over a stream (which is also referred to as data stream) can be considered as input to another stream processing computation.

The following gives an example of finding the maximum over a stream s of numbers by SQL query. The corresponding SQL query is:
SELECT MAX(*) FROM s

The stream s consists of arriving numbers and retractions of numbers (shown as struck out numbers):
1 3 8 6 5 5 [symbol] 1

[symbol]

[symbol]

The stream processing system will read the sequence and simultaneously track the maximum of the sequence. For example, after reading 1, the maximum is 1. After processing 3, the maximum will no longer be 1, but 3. As output, the following stream of numbers and retractions of numbers can be expected:
1 [symbol] 3 [symbol] 8 [symbol] 6 [symbol] 5

In this description, it is usually considered that the output to be just a stream of updates, without explicit retractions, the output is as follows:
1 3 8 6 5

Besides the obvious applications of real-time analysis of data over a changing data base (change data capture), retractions naturally occur as the result of complex queries even over data streams that initially come without retractions.

For example, it is assumed that there is a running online book store and an analysis of a stream s of book sales is required. Conceptually, it is considered a table with two columns: bookid and price. If tracking the maximum price of any book that has been sold between 1 and 3 times, the query can be formulated as a nested SQL query as follows:

SELECT MAX(price) FROM (
SELECT bookid, count(*) AS c, price1 FROM s
GROUP BY bookid, price)
WHERE c >= 1 AND c <= 3

The query within parenthesis takes the input stream s and, conceptually, turns it into an intermediate table t with three columns: bookid, c, price, where c is the number of times that bookid has been sold at price price. The outer SQL query, conceptually, builds a table t′ containing those rows of t for which 1≤c≤3 and computes the maximum of the price column in t′. Now, even if the stream s does not contain retractions, the stream t′ that is input to the MAX function will contain retractions: if, for some pair bookid, price, the count c increases from 3 to 4, then bookid, price is present in t yet be retracted from t′.

One can mathematically prove that computing even simple aggregate functions such as the maximum or minimum over a stream with retractions, in the worst case, necessitates storing the entire data stream, that is, materializing the intermediate tables. Thus, the existing stream processing systems have only two choices:
supporting aggregate functions only over streams without retractions; or
storing the entire data stream to support aggregate functions over streams with retractions.

Since retractions naturally arise even when analyzing data streams that originally do not contain retractions, any stream processing system not supporting retractions obviously cannot answer even simple SQL queries as shown in the above example.

In addition, storing the entire data stream to support retractions is practically infeasible for data streams that arrive at several GB (gigabyte)/s or even several TB (Terabyte)/s, because
storage of this capacity is expensive;
storage of this capacity is by several orders of magnitude slower than RAM or CPU cache and thus severely impacts the stream processing throughput and output latency;
storage of this capacity is complex, as it requires mechanisms for load balancing, fault recovery, transfer.

Moreover, in some cases, tracking an approximate answer for each group can be infeasible when the number of groups is large, for example, the number of all IPv6 addresses, which exceeds the amount of addressable memory in most systems.

As described above, answering even simple aggregate queries over streams with retractions may necessitate storing the entire data stream, which may easily require storing several GB/s. This is a mathematically proven unbreakable information-theoretic limit.

In view of the above technical problem, the present disclosure proposes a solution in which events/records in the stream are no longer stored, instead, a proper structure is used to analyze the events/records in the stream and give an approximate answer to the aggregate function. In fact, in many applications, not the exact values of aggregate functions are needed. Indeed, it is sufficient to compute values to within a precision that is sufficiently high to make decisions, higher than that of measuring devices, and higher than that of the device displaying the results.

Therefore, a set of approximate aggregate functions (e.g., aggregate SQL functions) with the following properties is proposed:
it is feasible for a user to choose the precision and error probability of the approximate answer, so as to arbitrarily high precision (accuracy) and arbitrarily low error probability, as will be described later, such precision and error probability will be guaranteed by means of mathematical proofs,
since the data structures for implementing the aggregate functions are properly selected, their memory use may be proportional to the logarithm to the size of the input stream (200 MB should be enough in most cases); in some cases, their memory use may depend on the precision and error probability desired by the user, the system user is thus free to find a trade-off between solution quality and the size of the occupied resource.

Among them, the supported aggregate functions would include maximum, minimum, percentiles/median, sums within groups, item counts of groups, maxima within groups, minima within groups, etc. All functions work for both streams with or without retractions, moreover, for with retraction case, the functions work on streams with unlimited retractions, and/or with unlimited length of records.

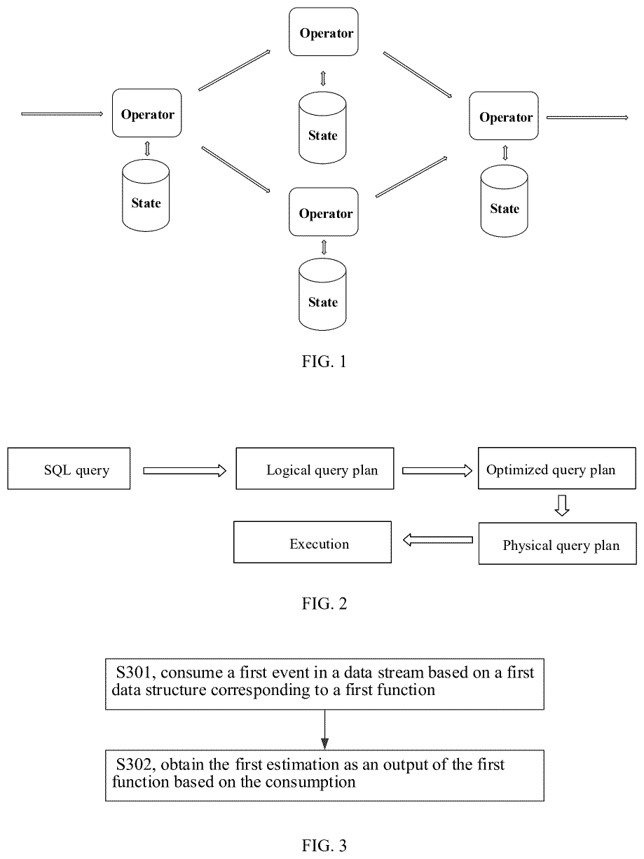

FIG. 1 shows a schematic structural diagram of an exemplary stream processing system according to an embodiment of the present disclosure. The system can include one or more operators and one or more states (which refer to memories corresponding to the operators) corresponding to the one or more operators, where each of the operators is a basic building block of stream processing program in the stream processing system and can include one or more operation functions, the operator can performing the following operations:
taking one or more streams as input,
computation on the input stream,
generating one or more output streams,
communicating bidirectionally with an internal memory called its state.

The output of one operator can be the input of another operator. The operators thus form a directed acyclic graph called data flow graph or logical query plan, an example of a data flow graph or logical query plan is shown in FIG. 1.

It should be noted that the operators and states shown in the figure are simply exemplary, and there could be other number of operators and states in actual applications.

In an embodiment, when there are multiple streams, the stream processing system can merge the multiple streams into one stream, and take the merged stream as an input of the operator, or the stream processing system does not merge the multiple streams into one stream and take the streams as inputs of the operator. In the latter case, the multiple streams can be streams on which different operations need to be performed, and the operations can be performed by one or more operators. For example, when a data stream [1, 2, 3, 4] needs to be negated (element-wise NOT) and summed, it can be operated by an operator containing negation and summation functions, that is, the operator first negates the data stream by the negation function to obtain a data stream [−1, −2, −3, −4], then sums the obtained data stream by the summation function to obtain a data stream [−10]. For another example, when a data stream [1, 2, 3, 4] needs to be negated and summed, it can be operated by two operators, one operator containing the negation function negates the data stream to obtain a data stream [−1, −2, −3, −4], then another operator containing the summation function sums the obtained data stream to obtain a data stream [−10].

In order to execute an SQL query, the stream processing system performs the following operation:
transforming the SQL expression into a logical query plan, by replacing SQL functions by operators;
transforming the logical query plan into a query plan that guarantees equivalent results but may yield higher throughput or lower latency (for example, by minimizing the size of intermediate computation results) using a query optimizer;
transforming the optimized logical query plan into a physical query plan by assigning the operators with their states (which refer to memories corresponding to the operators) to computational nodes on a cluster with the goal of maximizing throughput and minimizing latency. The system may place several operators on the same cluster node, but also can also split one operator among several cluster nodes;
executing the physical query plan by taking care of data transmission between the operators and the cluster nodes that they are residing on, takes care of making and restoring back-ups of the state in case of node failures. The process of executing an SQL query is shown in FIG. 2.

By adopting the technical solution of the present disclosure, the stream processing system can be a SQL-programmable stream processing system with a set of approximate aggregate SQL functions that allow the stream processing system to answer aggregate queries
over streams with/without retractions
containing records of unbounded length
in logarithmic memory (the memory use grows logarithmically with stream length)
with arbitrary user-definable solution quality requirements

The resource usage of this system (i.e., the size of the resource occupied by this system) depends on user-defined quality requirements of the solution, allowing the user to achieve a trade-off between solution quality and the size of the occupied resource. In many use cases, the memory requirement is small enough to fit into CPU (Central processing Unit) cache.

The present disclosure provides a data processing method, which may be applied to an operator, e.g., in the stream processing system mentioned above. The main idea is to introduce the accuracy of output of aggregate functions, and analyze records/events in an input data stream by using proper data structures whose occupied resource is related to the accuracy and subject to some requirements, thereby realizing trade-off between limited memory consumption and quality.

The embodiments of the present disclosure will be elaborated with reference to accompanying figures. Reference may be made to FIG. 3, the data processing method may include the following operations.
S301, consume a first event in a data stream based on a first data structure corresponding to a first function.
S302, obtain the first estimation as an output of the first function based on the consumption.

The data stream can be a sequence of events, where an event is an arrival, retraction, or update of data. For example, the data stream can be a sequence of online book store orders, or a sequence of machine health measurements, or a sequence of row insertions, row deletions, and row updates in a data base table. The first event in the data stream can be an arrival of data or a retraction of data, where the arrival of data is an event of row insertion, and the retraction of data is an event of row deletion, and a row update involves an event of row insertion and an event of row deletion, where the event of row deletion is followed by the event of row insertion. The data stream can be a stream without retraction in which each of the first events is not the retraction of data, or a stream with retraction in which one of the first events is the retraction of data. It should be noted that the table in the present disclosure is simply for illustration purpose, the data stream processing system does not maintain the real table.

The first function is used for finding a target value for a target attribute in the data stream, and the first function may be an aggregate function, such as maximum, minimum, percentiles/median, sums within groups, item counts of groups, maxima within groups, minima within groups, etc., and the first function may take the first event in the data stream as an input, and gives a first estimation as an output. Taking the data stream of online book store orders as an example, the target attribute may be selling price, so the first function is used for finding a target value, such as the maximum, minimum, the percentiles/median, the sums within groups, the item counts of groups, the maxima within groups, the minima within groups, etc. with respect to the selling price.

The first data structure here is a data structure corresponding to the first function, and can be used for analyzing the first event in the data stream during the obtaining of the first estimation based on the first function.

The consumption of the first event means that newly arrived data has to be added in the data structure or data already existed in the data structure has to be retracted. The process of consuming the first event can be considered as a process of reading the first event only once.

In an embodiment of the present disclosure, before consuming the first event, the method includes: receiving the data stream, where the data stream includes the first event.

Continuing to refer to the example of the data stream of online book store orders, each event can have attributes such as book ID, selling price, each of which takes a value, the data stream can be considered as a potentially infinite table with two columns: bookid and price, as shown in Table 1.

TABLE 1

| bookid | price |
|---|---|
| 1 | 10 |
| 1 | 10 |
| 2 | 9 |
| 3 | 12 |
| 2 | 8 |
| 1 | 11 |

When a book is sold, an arrival of data is inserted, for example, if a book with a bookid of 2 and a price of 9 is sold, then an event which is an arrival of data is inserted in to Table 1, the updated table is shown in Table 2, with the last line being inserted.

TABLE 2

| bookid | price |
|---|---|
| 1 | 10 |
| 1 | 10 |
| 2 | 9 |
| 3 | 12 |
| 2 | 8 |
| 1 | 11 |
| 2 | 9 |

If we want to find the highest price of any book that has been sold 2 times at a certain price in Table 2, the table 2 is turned into Table 3 according to corresponding query language.

TABLE 3

| bookid | c | price |
|---|---|---|
| 1 | 2 | 10 |
| 2 | 2 | 9 |

Where c in the second column represents the count of sales, and the finding result is books with a bookid of 1 and a selling price of 10. At this time, if another book with the bookid of 2 and the price 9 is sold out, then for the second entry in Table 3, the count c increases from 2 to 3, so this entry is retracted from Table 3 since we are looking for book(s) which has been sold 2 times, which is shown in Table 4.

TABLE 4

| bookid | c | price |
|---|---|---|
| 1 | 2 | 10 |
| [symbol] | [symbol] | [symbol] |

In this case, the second entry in Table 4 is the retraction of data.

In the present disclosure, a size of a resource occupied by the first data structure in a memory is determined according to an accuracy of a first estimation and with a sublinear cost, and the first estimation is an estimation of the target value. In an embodiment, instead of giving an exact output, it is proposed to give an estimation within a precision, as long as the precision of the estimation is sufficiently high to make decisions, or the precision of the estimation is higher than that of measuring devices, or the precision of the estimation is higher than that of the device displaying the results. Therefore, the accuracy of the first estimation is introduced to control the quality (or precision) of the first estimation. Such accuracy would be in a correlation with the size of the resource occupied by the first data structure in the memory, that is, the higher the accuracy (which means the precision of the first estimation is higher), the larger the size of the resource occupied, and the worse the accuracy (which means the precision of the first estimation is lower), the smaller the size of the resource occupied. In an embodiment, a higher value of the accuracy indicates higher precision (better accuracy), or in another embodiment, a smaller value of the accuracy indicates better accuracy, which is not limited in the embodiments of the present disclosure. In the case where the higher value of the accuracy indicates higher precision, the value of the accuracy would be in a positive correlation with the size of the resource occupied by the first data structure in the memory, and in the case where the smaller value of the accuracy indicates lower precision, the value of the accuracy would be in a negative correlation with the size of the resource occupied by the first data structure in the memory, in the following, the embodiments of the present disclosure will be described by taking the latter case as an example. So the compromise on the quality of the first estimation would consequently bring some benefits in terms of the resource usage. Besides, the first data structure is selected in such a way that the size of the resource occupied by the first data structure is with a sublinear cost (the cost of the resource occupied by the first data structure is in a sublinear form), where the sublinear cost may be the cost of a sublinear memory (e.g., a logarithmic memory). That is, the size of the resource occupied by the first data structure may be sublinear, so when data amount increases, the size of the resource occupied will be small enough to fit into CPU cache.

Therefore, comparing with the existing solution where no consideration was given on the size of the occupied resource, in the present disclosure, the first data structure for dealing with the first event is properly selected so that a trade-off between the quality and the size of the occupied resource can be achieved. In this way, the data stream with or without retraction can be processed by using the first data structure, without storing the entire data stream, and the data structure can contain events of unbounded length, the memory use grows in an expected way with length of the data stream, thus reducing the memory requirement.

Different first functions can have corresponding first data structures, In an embodiment. depending on the first function, the first data structure can be based on one of the followings: an exponential histogram, a count-min sketch and variants of the exponential histogram, it should be noted that the first data structure can also be in other form, as long as it is subject to resource usage requirement (sublinear cost) and the accuracy, which is not limited in the embodiments of the present disclosure.

In an embodiment of the present disclosure, the accuracy can be set by a user. In this way, the trade-off between the quality and the size of the occupied resource can be flexibly controlled by the user.

In an embodiment of the present disclosure, the first function can be one of the following: a function for finding the maximum for a target attribute in the data stream, a function for finding the minimum for a target attribute in the data stream, a function for finding the k-th smallest value in the data stream, a function for finding a percentile in the data stream, a function for finding a median in the data stream.

In an embodiment, the data stream can be partitioned into multiple groups based on the attribute of the event, for example, the data stream in Table 2 can be partitioned into three groups based on bookid attribute (an example of the target attribute), the first function can be one of the followings: a function for finding a count over the target attribute of members in each group, a function for finding a sum over the target attribute of members in each group. The first function can also be one of the followings: a function for finding the maximum for the target attribute in each of several (which is also referred to as first number mentioned below) groups in the data stream, a function for finding the minimum for the target attribute in each of several groups in the data stream, where the several groups can be chosen by a user, which is not limited in the embodiment of the present disclosure. The above first functions will be described in detail below.

In an embodiment of the present disclosure, operation S301 of consuming the first event in the data stream based on the first data structure corresponding to the first function and the accuracy of the first estimation includes the following operations.
S3011, determine whether the first event is an arrival of data or a retraction of data. As described above, the arrival of data can be an event of row insertion, and the retraction of data can be an event of row deletion.
S3012A, upon determining that the first event is the arrival of data, consume the first event by using a first procedure; or
S3012B, upon determining that the first event is the retraction of data, consume the first event by using a second procedure.

In an embodiment of the present disclosure, the first target value is one of a maximum for the target attribute in the data stream, a minimum for the target attribute in the data stream or a k-th smallest value for the target attribute in the data stream, where k is specified in the first function.

In an embodiment, when the first function is a function for finding the maximum for a target attribute in the data stream, or a function finding the minimum for a target attribute in the data stream, the first target value is one of a maximum for the target attribute in the data stream, or a minimum for the target attribute in the data stream, taking the data stream shown in Table 2 as an example, the target attribute can be the selling price, the first function is used for finding the maximum or the minimum for the selling price in the data stream. It should be noted the solution of the present disclosure is also applicable to the case where the data stream is the stream with retraction.

Syntax of the first function for finding the maximum for a target attribute in the data stream can be:
SELECT APPROX_MAX(a, ε) FROM s

Where s represents the data stream with or without retraction, a represents the target attribute (which is also referred to as attribute name below) of the data stream, and ε represents the accuracy of the first estimation (estimation of the maximum) and can be set by the user, and the accuracy ε>0. The accuracy can also be predefined.

An output of this function is a stream of estimates, where the most recent estimate m (which is the first estimation mention above) differs by a factor of at most (1+ε) from the maximum value MAX(a) of the attribute a over the not retracted records (which are also referred to as events mentioned above) in the data stream s, where the maximum value MAX(a) is the real maximum value for the attribute name a in the data stream s.

Syntax of the first function for finding the minimum for a target attribute in the data stream can be:
SELECT APPROX_MIN(a, ε) FROM s

Where s represents the data stream, a represents the target attribute (which is also referred to as attribute name below) of the data stream, and ε represents the accuracy of the first estimation (estimation of the minimum) and may be set the user, and the accuracy ε>0. The accuracy can also be predefined.

An output of this function is a stream of estimates, where the most recent estimate m (which is the first estimation mention above) differs by a factor of at most (1+ε) from the minimum value MIN(a) of the attribute a over the not retracted records in the data stream s, where the minimum value MIN(a) is the real minimum value for the attribute name a in the data stream s.

Note that the outputs to a query SELECT APPROX_MIN(a, ε) from s can be computed by negating the values in the output of a query SELECT APPROX_MAX(a, ε) from s′, where the stream s′ is the same as s with the values of attribute a negated, which is similar to computing MIN(a) in the data stream s by negating the MAX(a) in the data stream s′. Thus, the following will only describe the realization of APPROX_MAX. For example, the data stream s is [2, 4, 5, −6, 7], the data stream s′ is [−2, −4, −5, 6, −7], the MIN(s)/approximate MIN(s) in the data stream sis −6, which is equal to negation of the MAX(s′)/approximate MAX(s′) in the data stream s′, where the MAX(s′)/approximate MAX(s′) is 6.

In an embodiment, when the first function is a function for finding the maximum for a target attribute in the data stream, or a function finding the minimum for a target attribute in the data stream, the first data structure can be an exponential histogram, which is created using the accuracy ε which may be predefined or set by the user. It is the one-dimensional special case of the radial histograms.

An exponential histogram consists of two maps A and B and two counters C and n such that:
A[i] for i∈ [symbol] counts the occurrences of numbers x such that (1+ε)ⁱ>x≤(1+ε)ⁱ⁺¹;
B[j] for j∈ [symbol] counts the occurrences of numbers x such that −(1+ε)^{j+1}<x≤−(1+ε)^{j};
C counts the occurrences of 0, which can be set by the user or set in any other way, which is not limited in the embodiments of the present disclosure;
n counts the total number of not retracted records.

Where x is the value for the target attribute a of events in the data stream, an interval between (1+ε)ⁱ and (1+ε)ⁱ⁺¹ and an interval between −(1+ε)^{j+1} and −(1+ε)^{j} are intervals set by the user in the exponential histogram based on the accuracy ε.

The present disclosure also allows for non-positive indices i and j in A and B to count the number of occurrences of numbers between 0 and 1 and between −1 and 0, respectively. When i and j are both positive integers, at least one interval greater than 1 and at least one interval less than −1 can be determined respectively. When i and j are both non-positive integers, an interval (0, 1], and an interval [−1, 0) can be determined respectively. In order to allow for efficient computations of sums over ranges like A[i]+A[i+1]+ . . . +A[i+l], it makes sense to store the map from whole numbers i and j to A[i] and B[j], respectively, in memory using balanced search trees or arrays.

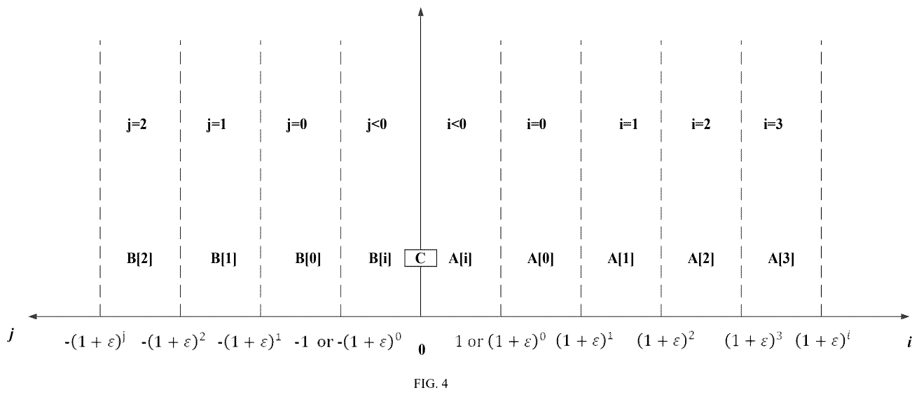

FIG. 4 shows a schematic diagram of an exemplary data structure, as shown in FIG. 4, there are multiple intervals on the horizontal axis, the multiple intervals include at least one interval less than 1 in which j is a positive integer, the interval [−1,0) in which j is a non-positive integer, the interval (0, 1] in which i is a non-positive integer, and the at least one interval greater than 1 in which i is a positive integer. Each of the intervals less than 0 corresponds to a parameter B[j], the point 0 corresponds to the parameter C, and each of the intervals greater than 0 corresponds to a parameter A[i].

Resource usage of the exponential histogram (the first data structure) is logarithmic and thus meets the preset requirement in which the number of counters stored by the exponential histogram is at most:

$$\frac{\vert log ( {M}^{+} ) \vert + \vert log ( - {M}^{-} ) \vert + \vert log ( {m}^{+} ) \vert + \vert log ( - {m}^{-} ) \vert}{log ( 1 + ε )} + 2$$

where
   M⁺ is the largest positive number stored in the histogram;
   M⁻ is the largest negative number stored in the histogram;
   m⁺ is the smallest positive number stored in the histogram;
   m⁻ is the smallest negative number stored in the histogram.

The number of bits occupied by each counter is proportional to the logarithm of the stream length. The memory overhead of an array or search tree realization will be larger only by a constant factor.

In an embodiment of the present disclosure, in the case where the first event is an arrival of data, the target value is a first target value for the target attribute in the data stream; where the first procedure includes: determining an interval into which a value for the target attribute of an event falls, where the interval is one of multiple intervals set based on the accuracy; and recording the value for the target attribute of the event by updating a parameter of the first data structure corresponding to the interval.

In an embodiment of the present disclosure, in the case where the first event is a retraction of data, where the second procedure includes: determining an interval into which a value for the target attribute of an event falls, where the interval is one of multiple intervals set based on the accuracy; and removing a record of the value for the target attribute of the event by updating a parameter of the first data structure corresponding to the interval. The retracted data can be the above arrival data, or data obtained in any feasible way, which is not limited in the embodiments of the present disclosure.

In an embodiment, as show in FIG. 4, the multiple intervals can be set by the user in the first data structure based on the accuracy, if the accuracy is determined, the multiple intervals are determined accordingly, the multiple intervals can be from the at least one interval less than 1 in which j is a positive integer, the interval [−1,0) in which j is a non-positive integer, the point 0, the interval (0, 1] in which i is a non-positive integer, and the at least one interval greater than 1 in which i is a positive integer. Each of the multiple intervals has a corresponding parameter, which is used for counting the number of times for which a value for the target attribute of an event falls in this interval. The parameter of the first data structure corresponding to the interval can be one of A[i], B[j] and C in the above exponential histogram. For example, each of the at least one interval less than 1 and the interval [−1,0) corresponds to a parameter B[j], the point 0 corresponds to the parameter C, and each of the at least one interval greater than 1 and the interval (0, 1] corresponds to a parameter A[i].

The process of consuming the first event in the data stream in the case where the first event is the arrival of data is as follows.

If an event whose target attribute a has value x is arriving on a data stream s:
1. Increment n.
2. If x=0, then increment parameter C in the first data structure based on the exponential histogram.
3. If x is positive, then compute the number i such that (1+ε)ⁱ<x≤(1+ε)ⁱ⁺¹ and increment parameter A[i] in the first data structure based on the exponential histogram.
4. If x is negative, then compute the number j such that −(1+ε)^{j+1}<x≤−(1+ε)^{j} and increment parameter B[j] in the first data structure based on the exponential histogram.

The process of consuming the first event in the data stream in the case where the first event is the retraction of data is as follows.

If an event whose target attribute a has value x is being retracted from a data stream s:
1. Decrement n.
2. If x=0, then decrement parameter C in the first data structure based on the exponential histogram.
3. If x is positive, compute the number i such that (1+ε)ⁱ<x≤(1+ε)ⁱ⁺¹ and decrement parameter A[i] in the first data structure based on the exponential histogram.
4. If x is negative, then compute the number j such that −(1+ε)^{j+1}<x≤−(1+ε)^{j} and decrement parameter B[i] in the first data structure based on the exponential histogram.

In an embodiment of the present disclosure, the operation S302 of obtaining the first estimation as an output of the first function includes: obtaining the first estimation as the first target value based on the parameter of the first data structure and the interval.

Continuing to take the case where the first function is the function for finding the maximum for the target attribute in the data stream as an example, after consuming an event in the data stream, output an approximation estimate (which is also referred to as first estimation above) m of the maximum value of the target attribute a as follows.

1. If there is a maximum i such that parameter A[i]>0, then, by construction of the exponential histogram, it holds that (1+ε)<MAX(a)≤(1+ε)ⁱ⁺¹.

Thus, as the approximation estimate m, output an arbitrary value between (1+ε)ⁱ and (1+ε)ⁱ⁺¹. It is also feasible to output the boundary of the interval, such as (1+ε)ⁱ or (1+ε)ⁱ⁺¹, which is not limited herein.

2. Otherwise, if parameter C>0, then MAX(a)=0.

Output the approximation estimate m: =0, in this case, the approximation estimate m is the real maximum value MAX(a).

3. Otherwise, if there is a minimum j such that B[j]>0, then, by the construction of the exponential histogram, it holds that −(1+ε)^{j+1}<MAX(a)≤−(1+ε)^{j}.

Thus, thus, as the approximation estimate m, output an arbitrary value between −(1+ε)^{j+1} and −(1+ε)^{j}. It is also feasible to output the boundary of the interval, such as −(1+ε)^{j+1} or −(1+ε)^{j}, which is not limited herein.

4. Otherwise, there is no maximum.

Output m:=−∞ or any other special value indicating that the maximum is undefined.

Thus, the determination of the approximation estimate m can be implemented by the following operations: first determine a parameter A[i], B[j] or C of the data structure, then determine i, j or 0 corresponding to the determined parameter A[i], B[j] or C; finally, determine the approximation estimate m based on i, j or 0 and the accuracy ε.

In an embodiment, when the first function is a function for finding the k-th smallest value in the data stream, a function for finding a percentile in the data stream, a function for finding a median in the data stream, the first target value is a k-th smallest value for the target attribute in the data stream, where k is specified in the first function.

Syntax of the first function for finding the k-th smallest value in the data stream can be:
SELECT APPROX_RANK(a, k, ε) FROM s

Where s represents a data stream with or without retraction, a represents the target attribute (which is also referred to as attribute name below) of the data stream, and ε represents the accuracy of the first estimation and may be predefined or set by the user, and the accuracy ε>0, k is a natural number.

An output of this function is a stream of estimates, where the most recent estimate m (which is the first estimation mention above) differs by a factor of at most (1+ε) from the value RANK(a, k), which is the real k-th smallest value of attribute name a among the not retracted records in the data stream s.

Syntax of the first function for finding a percentile in the data stream can be:
SELECT APPROX_PERCENTILE(a, p, ε) FROM s

Where s represents a data stream with or without retraction, a represents the target attribute (which is also referred to as attribute name below) of the data stream, and ε represents the accuracy of the first estimation and may be predefined or set by the user, the accuracy ε>0, and rational pε[0,1].

An output of this function is same as that of SELECT APPROX_RANK(a, pn, ε) FROM s, where n is the total number of records on s that have not been retracted.

Syntax of the first function for finding a median in the data stream can be:
SELECT APPROX_MEDIAN(a, ε) FROM s

Where s represents a data stream with or without retraction, a represents the target attribute (which is also referred to as attribute name below) of the data stream, and ε represents the accuracy of the first estimation and may be predefined or set by the user.

An output of this function is same as that of SELECT APPROX_PERCENTILE(a, 0.5, ε) FROM S.

Continuing to take the case where the first function is the function for finding the k-th smallest value in the data stream as an example, after consuming any event on the data stream s, to compute an estimate m (which is also referred to as first estimation above) of the k-th smallest value as follows:
1. Compute the three sums:

$${S}_{1} [ j ] := {\sum }_{j \leq ℓ} B [ ℓ ] , {S}_{2} := {\sum }_{ℓ = - ∞}^{ℓ = ∞} B [ ℓ ] + C , {S}_{3} [ i ] := {S}_{2} + {\sum }_{ℓ \leq i} A [ ℓ ] .$$

2. If there is a maximum j such that parameter S₁[j]≥k, by the construction of the exponential histogram, it holds that −(1+ε)^{j+1}<RANK(a, k)≤−(1+ε)^{j}.

Thus, the output estimate m is an arbitrary value between −(1+ε)^{j+1} and −(1+ε)^{j}.
3. Otherwise, if parameter S₂≥k, then RANK(a, k)=0.

Thus, the output estimate m=0,
4. Otherwise, if there is a minimum i such that parameter S₃[i]≥k, then, by construction of the exponential histogram, it holds that (1+ε)ⁱ<RANK(a,k)≤(1+ε)ⁱ⁺¹.

Thus, the output estimate m is an arbitrary value between (1+ε)ⁱ and (1+ε)ⁱ⁺¹.
5. Otherwise, there is no k-th smallest value.

The output estimate m=⊥ or any other special symbol that the result is undefined.

Where the parameters B[ [symbol] ], C and A[ [symbol] ] are similar to the abovementioned parameters B[j], C and A[i] in the data structure of exponential histogram for the first function for finding the maximum in the data stream.

The present disclosure simply describes the computation of estimates for the APPROX_RANK function, that is, the approximation of the k-th smallest value of target attribute a. The other two functions APPROX_PERCENTILE function, APPROX_MEDIAN function are just special cases and can be computed by choosing k depending on n, where n is stored in the exponential histogram.

In an embodiment of the present disclosure, where the first data structure is based on an exponential histogram, and the size of the resource occupied by the first data structure is proportional to a logarithm of a length of the data stream and logarithms of maximum and minimum absolute values in the data stream.

For the APPROX_MAX function, the APPROX_MIN function, the APPROX_RANK function, the APPROX_PERCENTILE function and the APPROX_MEDIAN function, the amount of required memory is proportional to the logarithm of the stream length, of the required precision, and of the maximum absolute value or maximum absolute reciprocal value of numbers in the stream.

When the target value is the first target value, it should be noted that the solution of the present disclosure is also applicable for the case where the first data structure of the first function adopts other different data structures, although the case where the first data structure is the exponential histogram is illustrated in the description.

In an embodiment of the present disclosure, in the case where the first event is an arrival of data, the target value is a third target value for the target attribute in a group defined by the first function, and the first data structure is based on a count-min sketch algorithm; where the first procedure includes: taking a value for the target attribute of an event in the group to update the first data structure.

Taking the data stream in Table 5 as an example, which includes one retraction event, it should be noted that the solution of the present disclosure is also applicable to the case where the data stream is the stream without retraction.

TABLE 5

| bookid | price |
|---|---|
| 1 | 10 |
| 1 | 10 |
| 2 | 9 |
| 3 | 12 |
| [symbol] | [symbol] |
| 2 | 8 |
| 1 | 11 |
| 2 | 9 |

The first function defines grouping the data stream by attribute “bookid”, the data stream can be grouped into three groups G1, G2 and G3, which are shown in Tables 6a, 6b, and 6c respectively. If the target attribute is “price”, the first function may be used for finding the third target value for the selling price in each of the three groups.

TABLE 6a-6c

| bookid | price |
|---|---|
| 1 | 10 |
| 1 | 10 |
| 1 | 11 |
| 2 | 9 |
| 2 | 8 |
| 2 | 9 |
| 3 | 12 |

In an embodiment, the count-min sketch algorithm is a sublinear space data structure for summarizing the data stream, which will be described in detail below with reference to an example.

In an embodiment of the present disclosure, the third target value is a sum over the target attribute of members in the group or a count over the target attribute of members in the group. As described example above, the first function is used for finding a sum over the selling price in each of the three groups, or a count over the selling price in each of the three groups. The real values corresponding to the third target values in the three groups are 31, 26 and 12 respectively when the third target value is the sum over the target attribute (selling price) of members, and the real values of the third target values for the three groups are 3, 3 and 1 respectively when the third target value is the count over the target attribute of members.

While counts and sums over attributes can easily be tracked in a data stream with retractions, there may be too many groups to track these values individually for each group. The following group collapsing functionality allows to estimate the most significant counts and sums.

Syntax of the first function for finding the sum over the target attribute of members in each group can be:
APPROX_SUM(a, ε, [symbol] ) GROUP BY g FROM s

Where s represents the data stream with or without retraction, a represents the target attribute (which is also referred to as attribute name below) of the data stream, and ε represents the accuracy of the first estimation and can be set by the user, and the accuracy ε>0, [symbol] represents an error probability and can also be predefined or set by the user, the error probability [symbol] ∈(0,1).

In addition, g is a list of attributes in the data stream s, which can be defined in the first function, for example, g is a list of two attributes: bookid and price in the above data stream of online book store orders, and v is a combination of values of g; for another example, g is the attribute bookid in data stream of Table 5, and v is one of values of g, for example, v is one of values 1, 2, 3 of bookid in data stream of Table 5. Then events whose values of the attributes g coincide with v can be called as “group v”, for example, the first, second and seventh events (first, second and seventh entries) in the data stream of Table 5 whose values of attribute bookid is 1 can be called as “group 1”, the third, sixth and eighth events (third, sixth and eighth entries) in the data stream of Table 5 whose values of attribute bookid is 2 can be called as “group 2”; and the fourth and fifth events (fourth and fifth entries) in the data stream of Table 5 whose values of attribute bookid is 3 can be called as “group 3”. The function allows for tracking sum sᵥ over some attribute within each group v, where the sum sᵥ is the real sum over some attribute in each group.

An output of this function is a stream of records (v,\tilde{s}ᵥ) (where \tilde{s}ᵥ is the first estimation of the third target value) such that the most recent record (v, \tilde{s}ᵥ) guarantees that, with probability at least 1− [symbol] , one has

$${s}_{v} \leq {\tilde{s}}_{v} \leq {s}_{v} + ε n ,$$

where
sᵥ is the real sum of values for the attribute a over all non-retracted records in group v,
\tilde{s}ᵥ is the estimate sum of values for the attribute a over all non-retracted records in group v,
n is the total number of non-retracted records in the stream s.

The rationale is that the ratio \tilde{s}ᵥ/n of the estimate sum to the total number of records is off by at most the accuracy ε.

Syntax of the first function for finding the count over the target attribute of members in each group can be:
APPROX_COUNT(*, ε, [symbol] ) GROUP BY g FROM s

Where s represents the data stream with or without retraction, ε represents the accuracy of the first estimation and can be predefined or set by the user, and the accuracy ε>0, [symbol] represents an error probability and can also be predefined or set by the user, the error probability [symbol] ∈(0,1). g is a list of attributes in the data stream s, which can be defined in the first function, for example, g is the attribute bookid in data stream of Table 5, and v is one of values of g, for example, v is one of values 1, 2 and 3 of bookid in data stream of Table 5. Then events whose values of the attributes g coincide with v can be called as “group v”.

An output of this function is similar as that of APPROX_SUM(a, ε, σ) GROUP BY g FROM s, where attribute name a is assumed to take the constant value 1. This function allows for tracking the count of events in each group v over some attribute within each group v.

The motivation is that \tilde{s}ᵥ/n is an estimate of the frequency of the value combination v that is off by at most the accuracy ε.

In an embodiment, the first data structure is based on the count-min sketch algorithm (which is also referred to as count-min sketch below), which is for storing the state corresponding to the first data structure, the count-min sketch supports three operations:
Initialization: taking an error probability [symbol] ∈(0,1), an accuracy ε>0, and associates a zero counter cᵥ with each value v.
Update: taking a value v (e.g. the value 1, 2, or 3 of bookid mentioned above), a (possibly negative) number c (e.g. the value of attribute a when v is 1, 2 or 3), and increments the counter cᵥ by c.
Query: taking a value v and returns an estimate \tilde{c}ᵥ such that, with probability at least 1−σ,

$${c}_{v} \leq {\tilde{c}}_{v} \leq {c}_{v} + ε n .$$

In the standard description of the count-min sketch, the values v are required to come from a fixed-size set V, which is infeasible in usage scenario of the present disclosure where there is no upper bound on the length of the values v. The restriction is imposed by the universal families of hash functions required to build the count-min sketch. To lift the restriction, it is sufficient to use a universal family of hash functions that allows V to be the set of all binary words of arbitrary length, as described above.

In an embodiment of the present disclosure, the size of the resource occupied by the first data structure is proportional to a reciprocal of the accuracy, a logarithm of a reciprocal of an error probability of the first estimation and a logarithm of a length of the data stream.

Resource usage of this data structure does not explicitly store any of the counts cy. The number of counters stored is proportional to

$$\frac{1}{ε} log \frac{1}{\text{?}} .$$

Each counter occupies a number of bits that is proportional to the logarithm of the total stream length. Additionally, one has to store the parameters of log 1/ [symbol] hash functions. In the example of the H₃ family described above these are binary matrices with a number of rows proportional to log 1/ε and a number of columns proportional to the length of the longest value v. Since the number of distinct values v, and hence groups, can be exponential in the length of v, the memory requirement for storing the hash functions is thus logarithmic in the error probability, accuracy, and number of groups.

In an embodiment of the present disclosure, when an event whose target attribute a has value x and whose attributes g have value v arrives on a data stream, that is when the first event is the arrival of data, taking the value for the target attribute of the first event in the group to update the first data structure can be, for example, sending an update (v, x) to the count-min sketch in the state.

In an embodiment of the present disclosure, when the first event is the retraction of data, the second procedure includes: taking a negative of the value for the target attribute of the event in the group to update the first data structure. For example, when an event whose target attribute a has value x, and whose attributes g have value v is retracted from the data stream, then send an update (v, −x) to the count-min sketch in the state.

When the target value is the third target value, it should be noted that the solution of the present disclosure is also applicable for the case where the first data structure of the first function is other different data structures, although the case where the first data structure is the count-min sketch algorithm is illustrated in the description.

For a scenario where it is unfeasible to track even approximate answers of groups due to the large number of groups, a group collapsing feature that guarantees good approximate answers only for a user-specified number of most significant groups is proposed.

In an embodiment of the present disclosure, the target value is a second target value for the target attribute among a first number of groups, and the first number is defined in the first function; where the first data structure is based on a second number of exponential histogram sets, and each of the exponential histogram sets includes a third number of exponential histograms, where the second number is determined based on an error probability defined in the first function. The first function can be a function for finding the maximum for the target attribute in each of the first number of groups in the data stream, or a function for finding the minimum for the target attribute in each of the first number of groups in the data stream, and accordingly, the second target value is the maximum for the target attribute in each of the first number of groups, or the minimum for the target attribute in each of the first number of groups. In an embodiment, the first number can be set by a user, for example, the first number is preset by the user in the first function, which is not limited in the embodiment of the present disclosure.

In this way, when the data stream is divided into multiple groups and to track maximum and minimum for each of the multiple groups, the number of groups may be too large to track an exponential histogram for each group, the group collapsing functionality of the present disclosure allows to estimate the maxima of the groups that are significant in the following sense, thus avoiding the situation that the large number of groups (e.g., the number of all IPv6 addresses) exceeds the amount of addressable memory in most systems. The group collapsing functionality refers to that only the first number of significant groups in all multiple groups are processed or calculated.

Syntax of the first function for finding the maximum for the target attribute in each of the first number of groups in the data stream can be:
APPROX_MAX(a, ε, [symbol] ) GROUP BY COLLAPSE (g, k) FROM s

Where s represents the data stream with or without retraction, g is a list of attributes in the data stream s, which can be defined in the first function, for example, g is the attribute bookid in data stream of Table 5, k is a natural number which can be set by the user in the function, a represents the target attribute (which is also referred to as attribute name below) of the data stream, and & represents the accuracy of the first estimation and may be predefined or set by the user, and the accuracy ε>0, [symbol] represents an error probability and can also be set by the user, the error probability [symbol] ∈(0,1).

An output of this function is a stream of records (v, \tilde{m}ᵥ) such that the most recent record (v, \tilde{m}ᵥ) guarantees that:
1) If group v is (k, ε)-significant, then, with probability at least 1− [symbol] , the estimate \tilde{m}ᵥ differs from mᵥ by a factor of at most (1+ε).
2) If group v is not (k, ε)-significant, then, with probability at least 1− [symbol] , the estimate \tilde{m}ᵥ takes the value 1 or any other value indicating that group v is not significant.

Events whose values of the attributes g coincide with v can be called as “group v”, for example, the first, second and seventh events (first, second and seventh entries) in the data stream of Table 5 whose values of attribute bookid is 1 can be called as “group 1”, the third, sixth and eighth events (third, sixth and eighth entries) in the data stream of Table 5 whose values of attribute bookid is 2 can be called as “group 2”; and the fourth and fifth events (fourth and fifth entries) in the data stream of Table 5 whose values of attribute bookid is 3 can be called as “group 3”. mᵥ represents the maximum value of a target attribute a among all non-retracted events belonging to group v. A group v is called (k, E)-significant if there are at most k other groups u such that mᵤ≥mᵥ or such that mᵤ is within a factor (1+ε) of mᵥ. Obviously, there can be at most k groups that are (k, ε)-significant, where k represents the first number mentioned above.

In an embodiment of the present disclosure, the first data structure can be stored in the state corresponding to the first function, and the first data structure can include the second number of exponential histogram sets, and each of the exponential histogram sets includes the third number of exponential histograms. For example, a first data structure includes d (the second number) exponential histogram sets, and each of d exponential histogram sets includes k²+k (the third number) exponential histograms, d may be calculated by the following formula: d=┌log 1/ [symbol] ┐.

[symbol] represents the error probability, there are d hash functions h₁, . . . , h_{d} for mapping arbitrarily long binary strings to a number {1, . . . , k²+k}, each hash function is chosen randomly and independently from a uniform family of hash functions, and the first data structure includes (k²+k)·d exponential histograms, each of which is similar to the histogram for finding the first target value above, and is denoted by Mᵢⱼ for i∈{1, . . . , d} and j∈{1, . . . , k²+k}. Each group of k significant groups is mapped to one of the k²+k histograms using a randomly chosen hash function. This random mapping is bad with a probability of at most ½. Thus, the random experiment is repeated d times in parallel with d random hash functions, so that the probability of all random mappings being bad is at most 2^{-d}= [symbol] .

On arrival or retraction of an event whose attribute a has value x and whose attributes g have value v, add or retract x for all exponential histograms Mᵢⱼ for i∈{1, . . . , d} and j=hᵢ(v), as described above for finding the first target value.

For memory requirements of this data structure: for each hash function, store a number of bits that is proportional to the logarithm of k and to the length of the longest value combination v of the attributes g. The total memory requirements are thus proportional to k² and proportional to the logarithm of the stream length, of the error probability, of the total number of groups, and of the accuracy.

In an embodiment of the present disclosure, in the case where the first event is an arrival of data, the first procedure for consuming the first event in the data stream incudes: for each of the exponential histogram sets, obtaining a first exponential histogram among the third number of exponential histograms in the exponential histogram set based on a value for a grouping attribute of an event, where the value of the grouping attribute is indicative of a group to which the event belongs; determining, in the first exponential histogram, an interval into which the value for the target attribute of the event falls, where the interval is one of multiple intervals set based on the accuracy; and recording the value for the target attribute of the event by updating a parameter of the first exponential histogram corresponding to the interval. The value for the grouping attribute of the event can be, for example, value 1, 2, or 3 of attribute bookid in book sales data stream of Table 5, when an event whose value of bookid is 1 arrives, then this event is grouped into G1 with bookid of 1.

In an embodiment, for each exponential histogram set, obtaining the first exponential histogram among the third number of exponential histograms in the exponential histogram sets based on the value for a grouping attribute of the event can be, for example, an event whose attribute g has a value of v is arriving on the data stream, for each of the second number of exponential histogram sets (each i∈{1, . . . , d}), randomly selecting (j=hᵢ(v)) one exponential histogram as the first exponential histogram among the third number of exponential histograms by applying hash function to the value v.

In an embodiment, the first exponential histogram is similar to the histogram for finding the first target value above, and the processes of determining the interval into which the value for the target attribute of the event falls, and recording the value for the target attribute of the event are also similar to those for find the first target value above, which will not be repeated here.

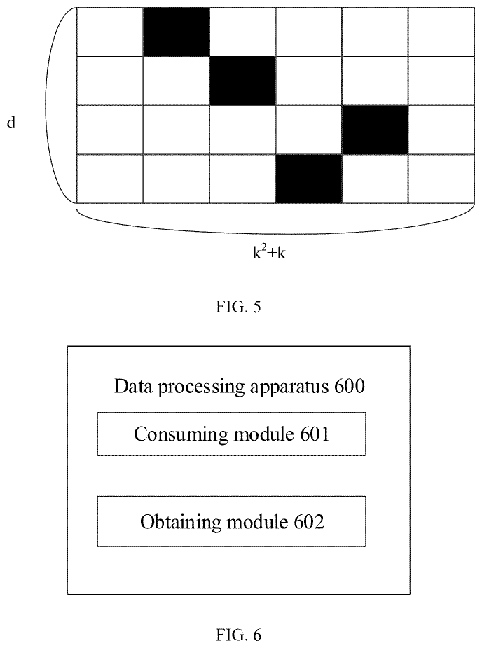

FIG. 5 shows a schematic diagram of an exemplary data structure, as shown in FIG. 5, d=4, k=2, the first, second and third numbers are 2, 4 (d), and 6 (k²+k) respectively, the data structure includes 4 exponential histogram sets, and each of 4 exponential histogram sets includes 6 exponential histograms. The first procedure includes: for each of 4 exponential histogram sets, obtaining 1 exponential histogram (which is shown by the black block in FIG. 5) among 6 exponential histograms in this exponential histogram set; then based on the obtained exponential histogram, performing determination of the interval and recording of the value for the target attribute of the event in a way similar to that of finding the first target value above.

In an embodiment of the present disclosure, in the case where the first event is a retraction of data, the second procedure for consuming the first event in the data stream includes: for each of the exponential histogram sets, obtaining a first exponential histogram among the third number of exponential histograms in the exponential histogram set based on a value for a grouping attribute of an event, where the value of the grouping attribute is indicative of a group to which the event belongs; determining, in the first exponential histogram, an interval into which the value for the target attribute of the event falls, where the interval is one of multiple intervals set based on the accuracy; and removing a record of the value for the target attribute of the event by updating a parameter of the first exponential histogram corresponding to the interval. The value for the grouping attribute of the event can be, for example, value 1, 2, or 3 of attribute bookid in book sales data stream of Table 5, when an event whose value of bookid is 1 arrives, then this event is grouped into G1 with bookid of 1.

In an embodiment, for each exponential histogram set, obtaining the first exponential histogram among the third number of exponential histograms in the exponential histogram sets based on the value for a grouping attribute of the event can be, for each of the second number of exponential histogram sets (each i∈{1, . . . , d}), randomly selecting (j=hᵢ(v)) one exponential histogram as the first exponential histogram among the third number of exponential histograms by applying hash function to the value v.

In an embodiment, the first exponential histogram is similar to the histogram for finding the first target value above, and the processes of determining the interval into which the value for the target attribute of the event falls, and removing the record of the value for the target attribute of the event are also similar to those for find the first target value above, which will not be repeated here.

In an embodiment of the present disclosure, after consuming the first event, the operation S302 of obtaining the first estimation as an output of the first function includes: obtaining candidate estimations based on the parameters of the first exponential histograms for the exponential histogram sets and the accuracy; determining a to-be-verified estimation based on the candidate estimations; and determining the first estimation as the second target value based on the first exponential histograms for the exponential histogram sets and the to-be-verified estimation.

In an embodiment of the present disclosure, in the case where the first function for finding the maximum for the target attribute in each of the first number of groups in the data stream, determining the first estimation as the second target value based on the first exponential histograms for the exponential histogram sets and the to-be-verified estimation includes: for each of the exponential histogram sets, determining, among the third number of exponential histograms in the exponential histogram set, a number of second exponential histograms of which estimations are not smaller than the to-be-verified estimation; and in a case that the number of second exponential histograms is not greater than the first number, outputting the to-be-verified estimation as the first estimation.

In an embodiment of the present disclosure, in the case where the first function for finding the minimum for the target attribute in each of the first number of groups in the data stream, determining the first estimation as the second target value based on the first exponential histograms for the exponential histogram sets and the to-be-verified estimation includes: for each of the exponential histogram sets, determining, among the third number of exponential histograms in the exponential histogram set, a number of second exponential histograms of which estimations are not greater than the to-be-verified estimation; and in a case that the number of second exponential histograms is not greater than the first number, outputting the to-be-verified estimation as the first estimation.

Continuing to take the case where first function for finding the maximum for the target attribute in each of the first number of groups in the data stream as an example, after consuming an event whose attributes g have the values v, the output estimate (which is also referred to as first estimation above) (v, \tilde{m}ᵥ) is computed in following two phases, the data structure includes d exponential histogram sets, and each exponential histogram set includes k²+k exponential histograms.

Phase 1. Generating a to-be-verified candidate estimate (to-be-verified candidate mentioned above).

For each i∈{1, . . . , d} and j=hᵢ(v), getting d candidate estimates \tilde{m}ᵢᵥ of the maximum from the exponential histogram Mᵢⱼ.

The to-be-verified candidate estimate \tilde{m}ᵥ is the minimum of all the obtained candidate estimates \tilde{m}ᵢᵥ.

Phase 2. Verifying (k, ε)-significance.

1. For each i∈{1, . . . d}:

Condition 1a. Count for how many j∈{1, . . . , k²+k} the maximum estimate (maximum estimation) from Mᵢⱼ is at least \tilde{m}ᵥ.

Condition 1b. If the number of Mᵢⱼ whose maximum estimate is at least \tilde{m}ᵥ is more than k, then outputting (v, ⊥).

2. If the number of Mᵢⱼ whose maximum estimate is at least \tilde{m}ᵥ is not greater than k for any i∈{1, . . . , d}, output the estimate (v, \tilde{m}ᵥ). Here the Mᵢⱼ whose maximum estimate is at least \tilde{m}ᵥ is the second exponential histogram mentioned above.

For all groups of the data stream, determining the maximum estimations in each exponential histogram in this exponential histogram set for each of d exponential histogram sets, and counting a number of second exponential histograms whose maximum estimations are not smaller than the to-be-verified estimation \tilde{m}ᵥ; when the number of second exponential histograms is not greater than k, outputting the to-be-verified estimation \tilde{m}ᵥ (which can indicate which group it belongs to, and also can be referred to as (v, \tilde{m}ᵥ)) as the first estimation; and when the number of second exponential histograms is greater than k, outputting (v, ⊥), in this case, the initially determined first exponential histogram is not (k, ε)-significant, since there are more than k exponential histograms which give greater maximum estimations.

In order to analyze the quality of the output estimation, the present disclosure first verifies that candidate estimates \tilde{m}ᵢᵥ from Phase 1 are good for (k, ε)-significant groups and then verifies that Phase 2 correctly verifies (k, ε)-significance with high probability.

Phase 1 quality, where
mᵥ be the true maximum value of target attribute a over the non-retracted records in group v,
\hat{m}ᵢᵥ be the true maximum value of target attribute a over the non-retracted records in all groups u for which hᵢ(u)=hᵢ(v),
Let \hat{m}ᵥ be the minimum of the \hat{m}ᵢᵥ.

Each exponential histogram Mᵢⱼ for i∈{1, . . . , d} tracks the values of target attribute a over all non-retracted records s in groups u such that j=hᵢ(u). Thus, the candidate estimate \tilde{m}ᵢᵥ, as argued above, differs from \hat{m}ᵢᵥ by a factor of at most (1+ε).

Assume that v is (k, ε)-significant, argue that \hat{m}ᵥ=mᵥ with high probability. For any i∈{1, . . . , d}, one has \hat{m}ᵢᵥ>mᵥ only if there is a group u such that hᵢ(u)=hᵢ(v) and mᵤ>mᵥ. There are at most k such groups u. Thus, for any i∈{1, . . . , d}, the probability

$$Pr [ {\hat{m}}_{iv} > {m}_{v} ] \leq \frac{k}{{k}^{2} + k} \leq \frac{1}{k + 1} \leq \frac{1}{2} .$$

Consequently, the probability

$$Pr [ {\hat{m}}_{v} > {m}_{v} ] = Pr [ ∀ i ∈ \{ 1 , … , d \} : {\hat{m}}_{iv} > {m}_{v} ] \leq {2}^{- d} \leq \text{?} .$$

That is, if group v is (k, ε)-significant, then with probability at least 1− [symbol] , then \hat{m}ᵥ=mᵥ. Thus, the final candidate estimate \tilde{m}ᵥ differs by mᵥ by a factor of at most (1+ε), as required.

Phase 2 quality. If group v is (k, ε)-significant, then, by definition, condition 1b in Phase 2 is not satisfied for any i, and (v, \tilde{m}ᵥ) is output, as desired.

If group v is not (k, ε)-significant, then (v, ⊥) is output unless condition 1b in Phase 2 is not satisfied for any i. Condition 1b in Phase 2 is not satisfied for a concrete i if one of the following two events happens.
Group v collides with an (k, ε)-significant group u under the hash function hᵢ, that is, hᵢ(v)=hᵢ(u). Since there are at most k groups that are (k, ε)-significant and hᵢ is drawn from a uniform family of hash functions with values in {1, . . . , k²+k}, this happens with probability at most

$$k \cdot \frac{1}{{k}^{2} + k} = \frac{2 k}{2 {k}^{2} + 2 k} .$$

At least two (k, ε)-significant groups u₁, u₂ collide under hᵢ, that is, hᵢ(u₁)=hᵢ(u₂). Since there are at most

$$\frac{k ( k - 1 )}{2}$$

pairs of such groups that may collide and hᵢ is drawn from a uniform family of hash functions with values in {1, . . . , k²+k}, this happens with probability at most

$$\frac{k ( k - 1 )}{2} . \frac{1}{{k}^{2} + k} = \frac{{k}^{2} - k}{2 {k}^{2} + 2 k} .$$

The probability that at least one of these two events happens for a concrete i is bounded from above by their sum

$$\frac{2 k}{2 {k}^{2} + 2 k} + \frac{{k}^{2} - k}{2 {k}^{2} + 2 k} = \frac{{k}^{2} + k}{2 {k}^{2} + 2 k} = \frac{1}{2} .$$

Thus, if group v is not (k, ε)-significant, then condition 1b in Phase 2 is not satisfied for any i with probability at most 2^{-d}= [symbol] . Consequently, (v, ⊥) is output with probability at least (1− [symbol] ), as required.

Syntax of the first function for finding the minimum for the target attribute in each of the first number of groups in the data stream can be:
SELECT APPROX_MIN(a, ε, [symbol] ) GROUP BY COLLAPSE (g, k) FROM s

Where s represents the data stream with or without retraction, g is a list of attributes in the data stream s, which can be defined in the first function, for example, g is the attribute bookid in data stream of Table 5, k is a natural number which can be set by the user in the function, a represents the target attribute (which is also referred to as attribute name below) of the data stream, and & represents the accuracy of the first estimation and may be predefined or set by the user, and the accuracy ε>0, [symbol] represents an error probability and can also be set by the user, the error probability [symbol] ∈(0,1).

An output of this function is a stream of records (v, \tilde{m}ᵥ) such that the most recent record (v, \tilde{m}ᵥ) guarantees that

If group v is (k, ε)-significant, then, with probability at least 1− [symbol] , the estimate my differs from mᵥ by a factor of at most (1+ε).

If group v is not (k, ε)-significant, then, with probability at least (1− [symbol] ), the estimate \tilde{m}ᵥ takes the value ⊥ or any other value indicating that group v is not significant.

Events whose values of the attributes in g coincide with v can be called as “group v”. mᵥ represents the minimum value of a target attribute a among all non-retracted events belonging to group v. A group v is called (k, ε)-significant if there are at most k other groups u such that mᵤ≤mᵥ or such that my is within a factor (1+ε) of mᵥ. Obviously, there can be at most k groups that are (k, ε)-significant, where k represents the first number mentioned above.

The function can be implemented by negating the estimates output by a SELECT APPROX_MAX(a, ε, [symbol] ) GROUP BY COLLAPSE (g, k) FROM s′ query, where the stream s′ is the same as s with the values of attribute a negated.

In an embodiment of the present disclosure, before consuming the first event, the method further includes: obtaining a query request, where the query request is indicative of the first function and the accuracy; and determining the first procedure or the second procedure based on the query request. The query request can be an SQL query, and can be imputed by the user. The corresponding first function and the accuracy can be determined based on the query request. In an embodiment, the query request can include the first function and the value of the accuracy, the first function and the accuracy can be determined directly based on the query quest, In an embodiment, the query request can include indexes of the first function and the accuracy, the first function and the accuracy can be determined based on the indexes included in the query request, which is not limited in the embodiments of the present disclosure.

When the target value is the second target value, it should be noted that the solution of the present disclosure is also applicable for the case where the first data structure of the first function is other different data structures, although the case where the first data structure is the exponential histogram sets is illustrated in the description.

The method according to any of implementations above can be realized as a product in several ways:
A stand-alone lightweight stream processing system, realized in embedded devices, such as programmable network switches or sensors,
As a stand-alone stream processing system provided as a cloud service to cloud application developers
As a module in more general stream processing systems provided as cloud service to cloud application developers.

In all cases, the users of the present disclosure are application developers or data analysts, and full discloses the provided aggregate functions and their quality guarantees.

FIG. 6 shows a schematic structural diagram of a data processing apparatus according to an embodiment of the present disclosure. As shown in FIG. 6, the data processing apparatus 600 may include:
a consuming module 601, configured to consume a first event in a data stream based on a first data structure corresponding to a first function, where the first function is used for finding a target value for a target attribute in the data stream, and a size of a resource occupied by the first data structure in a memory is determined according to an accuracy of a first estimation and with a sublinear cost, and the first estimation is an estimation of the target value; and
obtaining module 602, configured to obtain the first estimation as an output of the first function based on the consumption.

In an embodiment of the present disclosure, the data processing apparatus can be realized as an operator mentioned, which can be added to existing stream processing system.

In an embodiment, the consuming module 601 is configured to:
determine whether the first event is an arrival of data or a retraction of data; and
upon determining that the first event is the arrival of data, consume the first event by using a first procedure; or
upon determining that the first event is the retraction of data, consume the first event by using a second procedure.

In an embodiment, where the target value is a first target value, the consuming module 601 is configured to:
determine an interval into which a value for the target attribute of an event falls, where the interval is one of multiple intervals set based on the accuracy; and
record the value for the target attribute of the event by updating a parameter of the first data structure corresponding to the interval.

In an embodiment, where the consuming module 601 is configured to:
determine an interval into which a value for the target attribute of an event falls, where the interval is one of multiple intervals set based on the accuracy; and
remove a record of the value for the target attribute of the event by updating a parameter of the first data structure corresponding to the interval.

In an embodiment, where the obtaining module 602 is configured to:
obtain the first estimation as the first target value based on the parameter of the first data structure and the interval.

In an embodiment, where the first data structure is based on an exponential histogram, and the size of the resource occupied by the first data structure is proportional to a logarithm of a length of the data stream and logarithms of maximum and minimum absolute values in the data stream.

In an embodiment, where the first target value is one of a maximum for the target attribute in the data stream, a minimum for the target attribute in the data stream or a k-th smallest value for the target attribute in the data stream, where k is specified in the first function.

In an embodiment, where the target value is a third target value for the target attribute in a group defined by the first function, and the first data structure is based on a count-min sketch algorithm;
where the consuming module 601 is configured to: take a value for the target attribute of an event in the group to update the first data structure.

In an embodiment, where the consuming module 601 is configured to: take a negative of the value for the target attribute of the event in the group to update the first data structure.

In an embodiment, where the size of the resource occupied by the first data structure is proportional to a reciprocal of the accuracy, a logarithm of a reciprocal of an error probability of the first estimation and a logarithm of a length of the data stream.

In an embodiment, where the error probability is set by a user.

In an embodiment, where the third target value is a sum over the target attribute of members in the group or a count over the target attribute of members in the group.

In an embodiment, where the target value is a second target value the a target attribute among a first number of groups, and the first number is defined in the first function;
where the first data structure is based on a second number of exponential histogram sets, and each of the exponential histogram sets includes a third number of exponential histograms, where the second number is determined based on an error probability defined in the first function.

In an embodiment, where the consuming module 601 is configured to:
for each of the exponential histogram sets, obtain a first exponential histogram among the third number of exponential histograms in the exponential histogram set based on a value for a grouping attribute of an event, where the value of the grouping attribute is indicative of a group to which the event belongs;
determine, in the first exponential histogram, an interval into which the value for the target attribute of the event falls, where the interval is one of multiple intervals set based on the accuracy; and
record the value for the target attribute of the event by updating a parameter of the first exponential histogram corresponding to the interval.

In an embodiment, where the consuming module 601 is configured to:
for each of the exponential histogram sets, obtain a first exponential histogram among the third number of exponential histograms in the exponential histogram set based on a value for a grouping attribute of an event, where the value of the grouping attribute is indicative of a group to which the event belongs;
determine, in the first exponential histogram, an interval into which the value for the target attribute of the event falls, where the interval is one of multiple intervals set based on the accuracy; and
remove a record of the value for the target attribute of the event by updating a parameter of the first exponential histogram corresponding to the interval.

In an embodiment, where the obtaining module 602 is configured to:
obtain candidate estimations based on the parameters of the first exponential histograms for the exponential histogram sets and the accuracy;
determine a to-be-verified estimation based on the candidate estimations; and
determine the first estimation as the second target value based on the first exponential histograms for the exponential histogram sets and the to-be-verified estimation.

In an embodiment, where the obtaining module 602 is further configured to:
for each of the exponential histogram sets, determine, among the third number of exponential histograms in the exponential histogram set, a number of second exponential histograms of which estimations are not smaller than the to-be-verified estimation; and
in a case that the number of second exponential histograms is not greater than the first number, output the to-be-verified estimation as the first estimation.

In an embodiment, where the first number is set by a user.

In an embodiment, where the consuming module 601 is further configured to:
obtain a query request, where the query request is indicative of the first function and the accuracy; and
determine the first procedure or the second procedure based on the query request.

In an embodiment, where the accuracy is set by a user.

In an embodiment, where the apparatus further includes:
a receiving module, configured to receive the data stream, where the data stream includes the first event.

An embodiment of the present disclosure provides a computing device cluster, including a processing circuitry for performing any of the above data processing methods.

An embodiment of the present disclosure provides an electronic device including processing circuitry for executing any of the above data processing methods.

In an embodiment, the electronic device may include a transceiver, a processor, and a memory. The memory may be configured to store code, instructions, and the like executed by the processor.

It should be understood that the processor may be an integrated circuit chip and has a signal processing capability. In an implementation process, operations of the foregoing method embodiments may be completed by using a hardware integrated logic circuit in the processor, or by using instructions in a form of software. The processor may be a general-purpose processor, a central processing unit (CPU), a graphics processing unit (GPU), a neural processing unit (NPU), a system on chip (SoC) or another programmable logic device, a discrete gate or transistor logic device, or a discrete hardware component. The processor may implement or perform the methods, the operations, and the logical block diagrams that are disclosed in the embodiments of the present disclosure. The general-purpose processor may be a microprocessor, or the processor may be any conventional processor or the like. The operations of the methods disclosed with reference to the embodiments of the present disclosure may be directly performed and completed by a hardware decoding processor, or may be performed and completed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium is located in the memory, and the processor reads information in the memory and completes the operations of the foregoing methods in combination with hardware in the processor.

It may be understood that the memory in the embodiments of the present disclosure may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random-access memory (Random Access Memory, RAM) and is used as an external cache. By way of example rather than limitation, many forms of RAMs may be used, and are, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchronous link DRAM, SLDRAM), and a direct rambus random access memory (Direct Rambus RAM, DR RAM).

It should be noted that the memory in the systems and the methods described in this specification includes but is not limited to these memories and a memory of any other appropriate type.

An embodiment of the present disclosure provides a chip, including an input/output (I/O) interface and a processor, where the processor is configured to call and run a computer program stored in a memory, to enable a device installing with the chip to perform any of the above data processing methods.

An embodiment of the present disclosure provides a computer-readable medium storing computer execution instructions which, when executed by a processor, causes the processor to execute any of the above data processing methods.

In an embodiment, the storage medium may be a memory.

An embodiment of the present disclosure provides a computer program product including program code for performing any of the above data processing methods.

A person of ordinary skill in the art may be aware that, in combination with the examples described in the embodiments disclosed in this specification, units and algorithm operations can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiment. Details are not described herein again.

In the several embodiments provided in this disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in this disclosure essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the operations of the methods described in the embodiments of this disclosure. The foregoing storage medium includes: any medium that can store program code, such as a USB flash drive, a removable hard disk, a read-only memory (ROM), a random-access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

Although the present disclosure describes methods and processes with operations in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform operations in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

1. A data processing method, comprising:
consuming a first event in a data stream based on a first data structure corresponding to a first function, wherein the first function is used for finding a target value for a target attribute in the data stream, wherein a size of a resource occupied by the first data structure in a memory is determined according to an accuracy of a first estimation and with a sublinear cost, and the first estimation is an estimation of the target value; and
obtaining the first estimation as an output of the first function based on the consumption.

2. The method according to claim 1, wherein consuming the first event in the data stream based on the first data structure corresponding to the first function comprises:
determining whether the first event is an arrival of data or a retraction of data; and
upon determining that the first event is the arrival of data, consuming the first event by using a first procedure; or
upon determining that the first event is the retraction of data, consuming the first event by using a second procedure.

3. The method according to claim 2, wherein the target value is a first target value;
wherein the first procedure comprises:
determining an interval into which a value for the target attribute of an event falls, wherein the interval is one of multiple intervals set based on the accuracy; and
recording the value for the target attribute of the event by updating a parameter of the first data structure corresponding to the interval.

4. The method according to claim 2, wherein the second procedure comprises:
determining an interval into which a value for the target attribute of an event falls, wherein the interval is one of multiple intervals set based on the accuracy; and
removing a record of the value for the target attribute of the event by updating a parameter of the first data structure corresponding to the interval.

5. The method according to claim 3, wherein obtaining the first estimation as an output of the first function based on the consumption comprises:
obtaining the first estimation as the first target value based on the parameter of the first data structure and the interval.

6. The method according to claim 3, wherein the first data structure is based on an exponential histogram, and the size of the resource occupied by the first data structure in the memory is proportional to a logarithm of a length of the data stream and logarithms of maximum and minimum absolute values in the data stream.

7. The method according to claim 3, wherein the first target value is one of a maximum for the target attribute in the data stream, a minimum for the target attribute in the data stream or a k-th smallest value for the target attribute in the data stream, wherein k is specified in the first function.

8. The method according to claim 2, wherein the target value is a second target value for the target attribute among a first number of groups, and the first number is defined in the first function;
wherein the first data structure is based on a second number of exponential histogram sets, and each of the exponential histogram sets comprises a third number of exponential histograms, wherein the second number is determined based on an error probability defined in the first function.

9. The method according to claim 8, wherein the first procedure comprises:
for each of the exponential histogram sets, obtaining a first exponential histogram among the third number of exponential histograms in the exponential histogram set based on a value for a grouping attribute of an event, wherein the value of the grouping attribute is indicative of a group to which the event belongs;
determining, in the first exponential histogram, an interval into which the value for the target attribute of the event falls, wherein the interval is one of multiple intervals set based on the accuracy; and
recording the value for the target attribute of the event by updating a parameter of the first exponential histogram corresponding to the interval.

10. The method according to claim 8, wherein the second procedure comprises:
for each of the exponential histogram sets, obtaining a first exponential histogram among the third number of exponential histograms in the exponential histogram set based on a value for a grouping attribute of an event, wherein the value of the grouping attribute is indicative of a group to which the event belongs;
determining, in the first exponential histogram, an interval into which the value for the target attribute of the event falls, wherein the interval is one of multiple intervals set based on the accuracy; and
removing a record of the value for the target attribute of the event by updating a parameter of the first exponential histogram corresponding to the interval.

11. The method according to claim 8, wherein obtaining the first estimation as an output of the first function based on the consumption comprises:
obtaining candidate estimations based on parameters of first exponential histograms for the exponential histogram sets and the accuracy;
determining a to-be-verified estimation based on the candidate estimations; and
determining the first estimation as the second target value based on the first exponential histograms for the exponential histogram sets and the to-be-verified estimation.

12. The method according to claim 11, wherein determining the first estimation as the second target value based on the first exponential histograms for the exponential histogram sets and the to-be-verified estimation comprises:
for each of the exponential histogram sets, determining, among the third number of exponential histograms in the exponential histogram set, a number of second exponential histograms of which estimations are not smaller than the to-be-verified estimation; and
in a case that the number of second exponential histograms is not greater than the first number, outputting the to-be-verified estimation as the first estimation.

13. The method according to claim 8, wherein the first number is set by a user.

14. The method according to claim 2, further comprising:
obtaining a query request, wherein the query request is indicative of the first function and the accuracy; and
determining the first procedure or the second procedure based on the query request.

15. The method according to claim 1, wherein the accuracy is set by a user.

16. A data processing apparatus, comprising:
a memory configured to store code; and
at least one processor configured to execute the code, to enable the apparatus to:
consume a first event in a data stream based on a first data structure corresponding to a first function, wherein the first function is used for finding a target value for a target attribute in the data stream, wherein a size of a resource occupied by the first data structure in a memory is determined according to an accuracy of a first estimation and with a sublinear cost, and the first estimation is an estimation of the target value; and
obtain the first estimation as an output of the first function based on the consumption.

17. The apparatus according to claim 16, wherein the apparatus is further to:
determine whether the first event is an arrival of data or a retraction of data; and
upon determining that the first event is the arrival of data, consume the first event by using a first procedure; or
upon determining that the first event is the retraction of data, consume the first event by using a second procedure.

18. The apparatus according to claim 17, wherein the target value is a first target value, the apparatus is further to:
determine an interval into which a value for the target attribute of an event falls, wherein the interval is one of multiple intervals set based on the accuracy; and
record the value for the target attribute of the event by updating a parameter of the first data structure corresponding to the interval.

19. The apparatus according to claim 17, wherein the apparatus is further to:
determine an interval into which a value for the target attribute of an event falls, wherein the interval is one of multiple intervals set based on the accuracy; and
remove a record of the value for the target attribute of the event by updating a parameter of the first data structure corresponding to the interval.

20. The apparatus according to claim 18, wherein the apparatus is further to:
obtain the first estimation as the first target value based on the parameter of the first data structure and the interval.
